(19) United States
(12) Patent Application Publication
(10) Pub. No.: US 2009/0177435 A1
(43) Pub. Date: Jul. 9, 2009

(54) Method, System and Computer Program Product for Locating a Measuring Device and for Measuring Large Objects

(76) Inventor: Mikko Heininen, Kruusila (FI)

Correspondence Address: HARRINGTON & SMITH, PC, 4 RESEARCH DRIVE, Suite 202, SHELTON, CT, 06484-6212, US

(21) Appl. No.: 12/224,756

(22) PCT Filed: Mar. 6, 2007
(86) PCT No.: PCT/FI2007/000058

§ 371 Date: Jan. 23, 2009

(30) Foreign Application Priority Data
Mar. 7, 2006 (FI) 20060223

(51) Int. Cl. G01B 11/03; G06F 15/00

(52) U.S. Cl. 702/150; 356/614

(57) ABSTRACT

For the measurement of a large object, a reference point known in the coordinate system of the measuring arm is located by using an optical locating system, when the measuring arm is in the first location. The sensors of the sensor-equipped measuring arm indicate how the measuring tip moves between the different positions of the measuring arm. The sensor-equipped measuring arm is transferred to a second location, in which a new reference point is located. Also in the second location, the sensors indicate how the measuring tip moves between the different positions of the measuring arm. The information indicating the location of the points to be measured is transformed to a common coordinate system by using the information on the location of the first and second reference point and information indicating the location of the measuring tip in each position of the measuring arm.

The present invention relates generally to the measuring of objects, i.e. to ascertaining certain physical dimensions of a certain solid object. The invention relates especially to measuring in such a case, when the object is so large that one sensor-equipped measuring arm does not reach all interesting points to be measured.

In engineering industry, many different kinds of objects are manufactured according to supplied drawings. In order to be able to approve the finished object, it has to be ascertained by measuring that at least certain important points of the object are at the correct places they should be. Although the exact location of only certain points of the object are determined in the measurement, it is usual to speak generally about “measuring an object”. The measurement is not necessarily very simple, if the object is of a complex structure and the points to be measured are located in places, which cannot be reached along a straight line from a reference point located outside the object.

FIG. 1 represents a known principle for using a sensor-equipped measuring arm for the measurement. The measuring arm 101 is a robot arm, the joints, telescopic sections and other movable sections of which are provided with sensors 102. The measuring arm is also called an articulated arm coordinate measurement device. When the measuring arm is moved to a position, in which the measuring tip 103 contacts a certain point of the object 104 to be measured, the location of the measuring tip (and thus of the point to be measured) in relation to a reference point can be calculated from the information provided by the sensors. When all important points of the object 104 to be measured have been measured in this way, desired distances, angles and other necessary information can be calculated from the location information of the points recorded to the memory. In known measuring device software, the reference point, i.e. the origin of the coordinate system is often located as a default in the base of the measuring arm.

The measuring arm 101 has a certain maximum dimension, which determines how large objects can be measured by the arrangement according to FIG. 1. Measuring larger objects requires that a test bench be built adjacent to or around the object, the bench having several fastening points, to which the lower end of the measuring arm 101 can be attached in its turn. When the location of these fastening points in relation to each other is exactly known, the coordinates measured from each fastening point can be transformed to a common coordinate system by a simple linear transformation. Alternatively, the test bench can be such that it can be used to transfer the object to be measured by a known transition, while the measuring arm stays in place.

However, one problem is that even a test bench will not necessarily be applicable for measuring arbitrary objects, if the object to be measured is very large or if it for some other reason has points, which the measuring arm cannot reach from any predefined fastening point. In addition, a test bench is a fixed installation, which is not easily moved, if the measurement should be performed somewhere else besides a special measuring room.

Other state-of-the-art measuring systems are disclosed in the publications U.S. Pat. No. 4,733,969 A; U.S. Pat. No. 5,748,505 A; U.S. Pat. No. 5,983,166; U.S. Pat. No. 6,023,850 A; US 2001/0021898 A1; US 2002/0013675 A1; and US 2004/0179205 A1. Further, the publications EP 1 152 212 B1 and EP 1 468 792 A2 deal with the use of a sensor-equipped measuring arm for tooling, in which dimensioning is important.

It is an object of the present invention to provide a system, arrangement and computer program product, by means of which it will be easy to measure an arbitrary, even a large object. It is also an object of the invention that the measuring system and arrangement according to it do not require massive fixed installations. Further, it is an object of the invention that the measurement according to it can be performed in an arbitrary space without excessive preliminary arrangements.

The objects of the invention will be achieved by placing an optical transmitter to the measuring area or to its proximity, and by using an optical receiver and sensors in the measuring arm, on the basis of the basic information supplied by which it is possible to automatically transform the measurements made from an arbitrary location to a common coordinate system.

The method of the invention is characterised in what is disclosed in the characterising part of the independent patent claim concerning the method.

The invention also relates to a system, which is characterised in what is disclosed in the characterising part of the independent patent claim concerning the system.

The invention further relates to a computer program product, which is characterised in what is disclosed in the characterising part of the independent patent claim concerning the computer program product.

An essential issue for the invention is the coordinate transformation between the common coordinate system and the coordinate system of the measuring arm. It can be determined unambiguously, when a sufficient number of positioning results are known so that the information representing them can be presented both in the coordinate system of the measuring arm and in the common coordinate system. This information will build a system of equations with an unambiguous solution, if there are at least as many non-trivial equations as there are unknowns.

A surprisingly simple optical locating system is sufficient to provide such positioning results, which bind the location of the measuring arm to the common coordinate system. It does not have to provide any other information besides a direction, which illustrates the direction in which the measuring tip of the measuring arm (or some other point the location of which is exactly known in relation to the measuring tip) currently is, seen from a fixed point of the optical locating system. For example, if the transmitter of the optical locating system transmits a rotating, fan-shaped light pattern, it is sufficient to know what the rotation of the fan-shaped light pattern in question was in relation to a reference direction at the time the fan-shaped light pattern hit the measuring tip.

When the location of the measuring arm in a common coordinate system can be determined in accordance with the invention, measurements of the same object can be made starting from several different locations of the measuring arm without having to determine these locations in any way in advance. The measuring tip can be moved in each individual location, and the sensors in the measuring arm provide exact information about the location of the measuring tip at any given time. Without the invention, this information would, however, only be known in the own coordinate system of the measuring arm, and there would exist no known connection between the measurements made from “random” locations of the measuring arm. For combining the measurements made from several different locations, they have to be transformed to a common coordinate system. The necessary transformation will be determined by an optical transmitter and an optical receiver, the one of which will be placed to the measuring space and the other one can be fastened to the measuring arm, when needed, so that the location between it and the measuring tip will be known. A sufficient number of positionings will be made in each location point of the measuring arm by means of optical devices so that the system of equations consisting of the results provided by them will be extensive enough to solve the coordinate transformation in an unambiguous manner. For obtaining the positioning results it is also possible to use other devices than optical ones; for example, inclination sensors.

When the location of the measuring arm now stays the same for the time being, and the measuring tip is moved alternately to each point to be measured, which it can reach from the location of the measuring arm in question, the sensors in the measuring arm provide the necessary information, on the basis of which the location of each measured point in the common coordinate system can be calculated by means of the coordinate transformation. For measuring the points, which the measuring tip cannot reach from the current location of the measuring arm, the measuring arm will be transferred to another location, in which a new coordinate transformation will be defined.

This specification discloses some exemplary embodiments of the invention which, however, do not restrict the invention. The description of the features of the invention and especially the use of the verb “comprise” do not exclude the possibility that the method and system of the invention could also have other features. It is possible to freely combine the features disclosed in the dependent claims, unless separately forbidden by this specification.

FIG. 1 illustrates a measuring arrangement according to the state of the art;

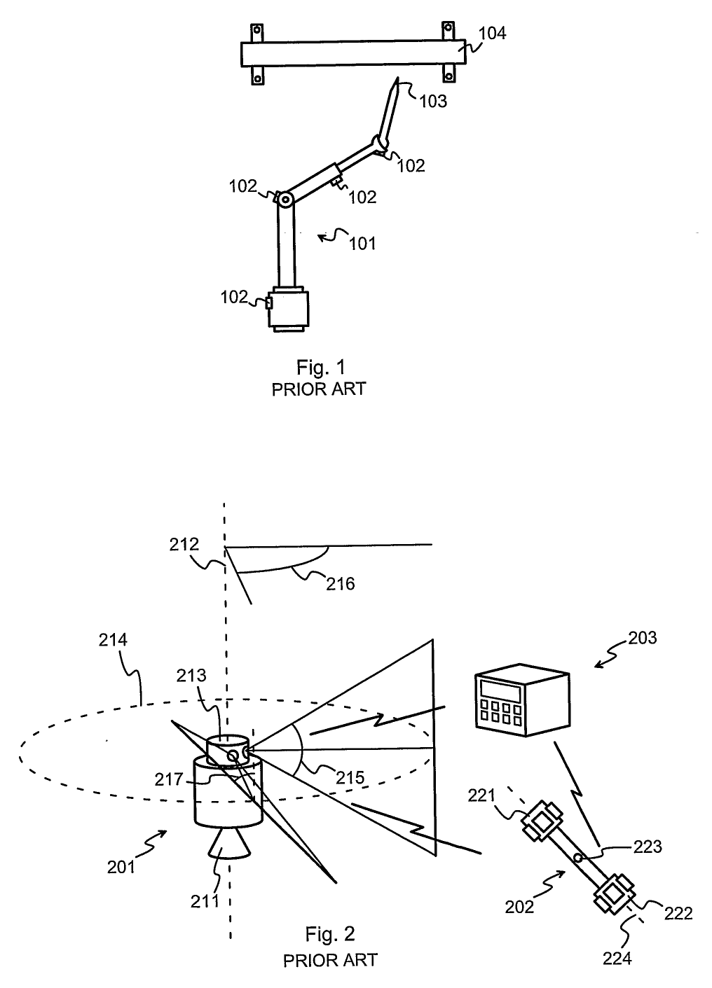

FIG. 2 illustrates a state-of-the-art positioning based on an optical transmitter and optical receiver;

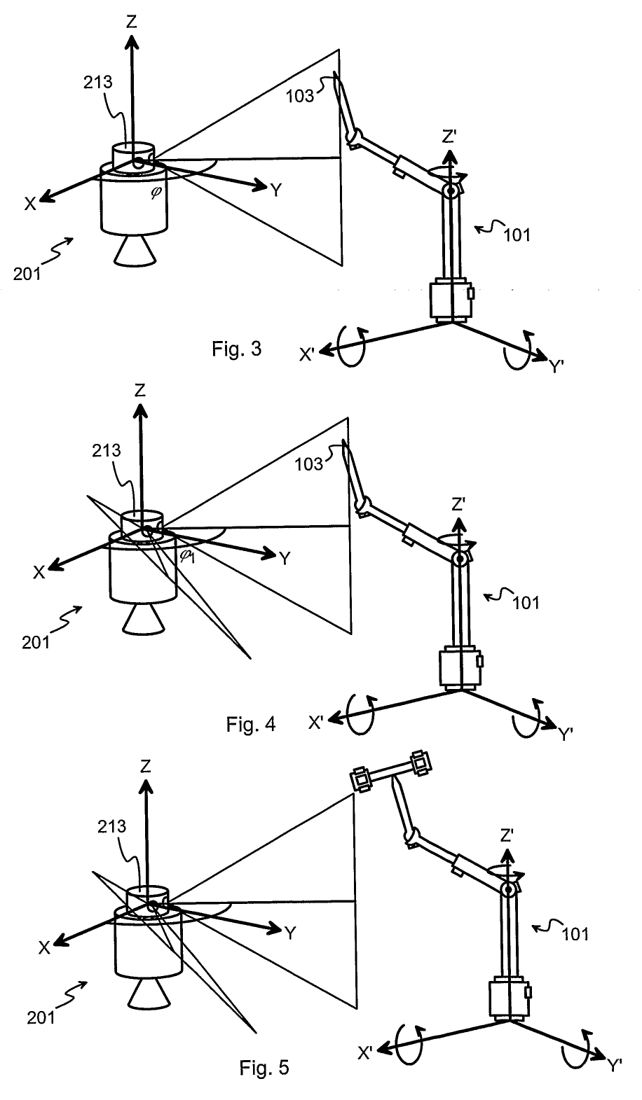

FIG. 3 illustrates an optical positioning according to an embodiment of the invention;

FIG. 4 illustrates an optical positioning according to a second embodiment of the invention;

FIG. 5 illustrates an optical positioning according to a third embodiment of the invention;

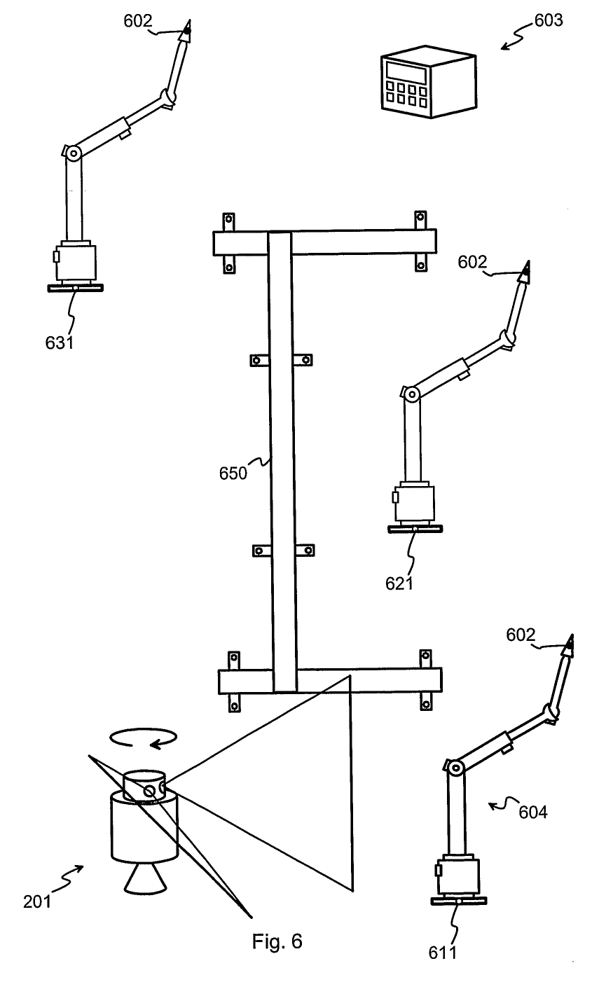

FIG. 6 illustrates a measuring system according to an embodiment of the invention;

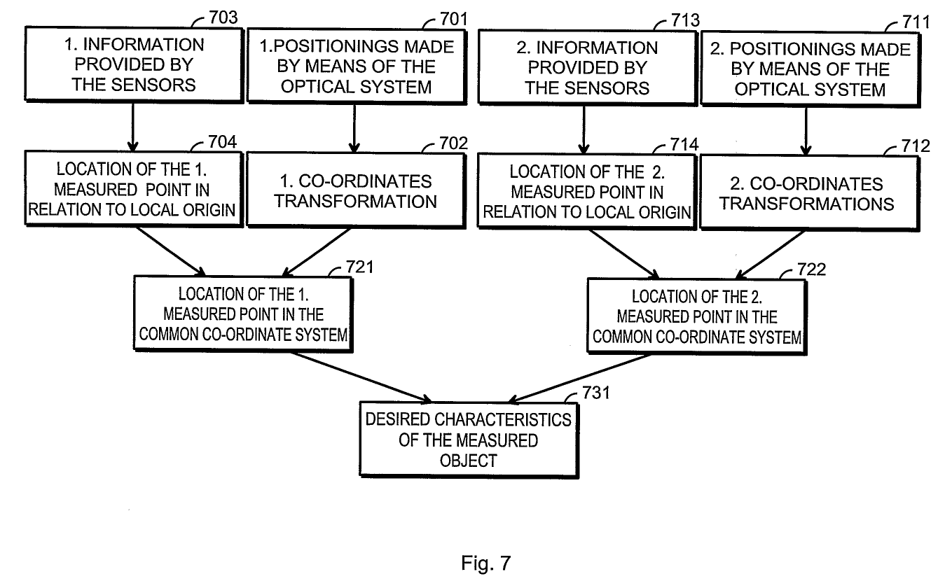

FIG. 7 illustrates the accumulation of information in a system according to an embodiment of the invention;

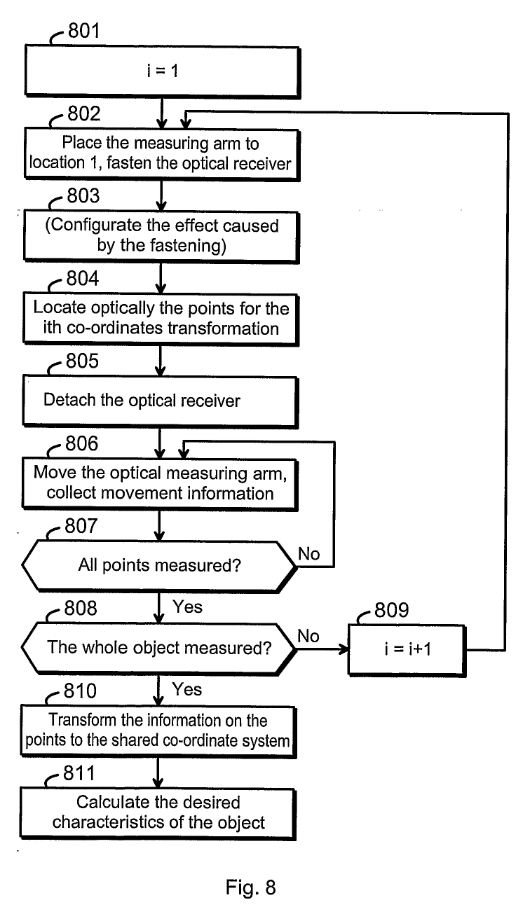

FIG. 8 illustrates a system according to an embodiment of the invention in the form of a flowchart; and

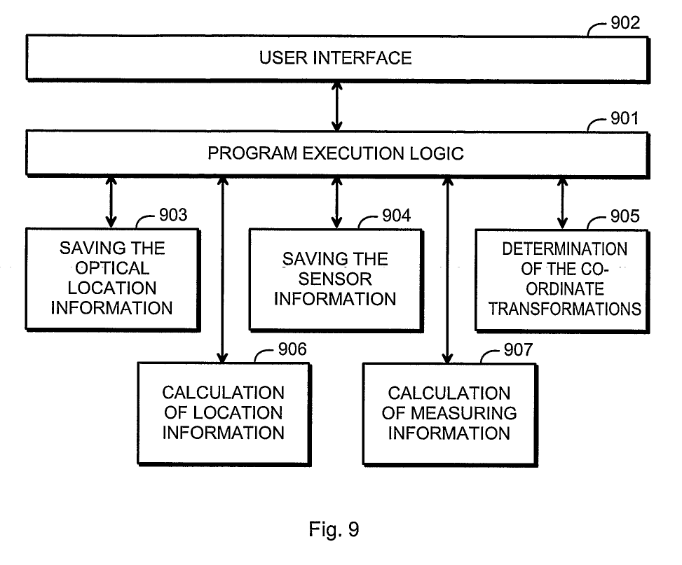

FIG. 9 illustrates a computer program product according to an embodiment of the invention.

FIG. 2 illustrates optical positioning, which is well known as a method. The system includes an optical transmitter 201 and an optical receiver 202, and a logic and recording unit 203, which has been shown here as a separate unit but which can also be entirely or partly integrated into the parts mentioned above. The optical transmitter 201 has fastening means 211 for fastening it so that its central axis 212 assumes a certain direction. The optical transmitter 201 has a rotating transmitter head 213, which rotates around the central axis 212 and transmits continuously at least two laser fan beams. In some systems there are more fan-shaped patterns. If an imaginary rectangular XYZ coordinate system is placed to the centre of the transmitter head 213, its Z axis will meet the central axis 212 and its X and Y axes (not illustrated separately in the figure) will be located in the plane of rotation 214. Each laser fan beam has a fan angle, i.e. a spread angle, of which the angle 215 is shown as an example in the figure. The extent of the fan angle as such has no other significance, but that it has to be large enough so that the laser fan beam will hit both (or all) sensors of the receiver to be described later. It is not advisable to use too large a fan angle, because in this case the influence of possible optical errors will increase. The farther away the optical receiver 202 is from the optical transmitter 201, the narrower should be the fan angle.

The direction of the line, along which the laser fan beam cuts the rotation plane 214 can be considered the nominal direction for the laser fan beam. The nominal directions for the two laser fan beams shown in FIG. 2 differ from each other by the angle 216. The laser fan beams are tilted to different angles in relation to the central axis 212. Of these angles, the angle 217 is shown as an example in FIG. 2. It is one of the characteristics of an optical transmitter that it is able to measure and report in a very exact manner the momentary rotational angle of the transmitter head 213 (i.e. the momentary direction of the laser fan beams) compared to a certain zero direction, which typically is the direction of the X axis in the above mentioned coordinate system.

In the known system illustrated in FIG. 2, the optical receiver 202 has at least two sensors 221 and 222. The intention is to measure the exact location of a point of the optical receiver 202 (or literally taken: such a point, the location of which is known in the coordinate system of the optical receiver 202) in relation to the optical transmitter 201. In this example it is presumed that the optical receiver 202 is elongated, that the sensors 221 and 222 are located at its ends, and that the point to be located is the centre 223 of the optical receiver 202.

The positioning is based on that the optical receiver 202 will always give a signal when it detects a laser beam hitting one of its sensors. The rotational angle of the transmitter head 213 of the optical transmitter corresponding to each signal will be noted. These signals will recur—with the exception of random errors—in an identical manner during each revolution of the transmitter head 213. When the time factors and the distance between the sensors relating to the detection are known, it is possible to calculate on the basis of the mutual timing of the accumulated hit signals the current geometry of the system, i.e. the distance of the centre 223 of the optical receiver from the optical transmitter 201, the height from the rotational plane 214 and the direction of the location in relation to the X axis of the optical transmitter 201, and the orientation of the optical receiver 202, i.e. in the case of FIG. 2, the direction of the longitudinal axis 224 of the elongated optical receiver 202 in the XYZ coordinate system of the optical transmitter 201.

The flow of information between different devices for carrying out the positioning described above and other technical details vary somewhat, depending on the type and the manufacturer of the system. In FIG. 2 it has been presumed that the optical transmitter 201, the optical receiver 202, and the logic and recording unit 203 are all able to communicate wirelessly with each other. A data communication connection between the optical receiver 202 and the logic and recording unit 203 will not necessarily be needed for the actual positioning at all, if the optical receiver 202 always informs of the hits only to the optical transmitter 201, from which the necessary information will be transmitted forward to the logic and recording unit 203. Any one or all of the above described wireless connections can be replaced with a conductor connection. The system can have several optical transmitters, which can use, for example, laser beams of different colours for separating the transmitters from each other. The optical receiver can have three or several sensors. In some cases the sensors of the optical receiver can be replaced by reflectors or transponders, in which case the detection of the hits will occur elsewhere, for example, in the same device which also operates as the optical transmitter.

Technical details of the optical locating system are not of a great significance for the present invention; it is sufficient when it is known that a certain system based on an optical transmitter and optical receiver is available and that it can be used for producing information representing the location of an arbitrary point in the own coordinate system of the optical locating system. However, it is advantageous if the optical locating system is simple, because in this case the manufacturing costs of the system of the present invention can be reduced and, on the other hand, the operational security and field competence of the system of the invention are better than if the optical locating were to require complex devices.

The technique of optical locating systems are disclosed, for example, in the publications WO 00/57133; U.S. Pat. No. 6,452,668; US 2003/025902; WO 01/65207; and U.S. Pat. No. 5,294,970.

Optical locating systems require a direct visual connection between the transmitter and receiver. These are typically intended to be used for geographical mapping in a free space or for the positioning of certain points of buildings, and they are not applicable for measuring large objects in the sense meant by the engineering industry, because it would typically be difficult to get the receiver placed to an arbitrary point to be measured.

In FIG. 3 there is shown a situation in which an optical transmitter 201 transmitting a fan-shaped light pattern and a measuring arm 101 are located in the same space. Because the fan-shaped light pattern is typically produced with a laser, it will next be called a laser fan beam. The laser fan beam hits the measuring tip 103 when the rotation of the transmitter head 213 is φᵢ. The coordinate system of the optical transmitter 101 will be called the (x, y, z) coordinate system, and the coordinate system of the measuring arm will now be called the (x′, y′, z′) coordinate system. In the first one of these, i.e. (x, y, z) coordinate system it is known that the measuring tip is located on the plane determined by the laser fan beam, to which the rotation φᵢ corresponds. Because the plane determined by the laser fan beam goes through the origin of the (x, y, z) coordinate system, and because the inclination of the laser fan beam in relation to the z axis is constant (see, for example, the angle 217 in FIG. 2), any known rotation φ is sufficient to unambiguously determine the plane corresponding to it in the (x, y, z) coordinate system. In general, the equation of such a plane is

cos(θ)sin(φ)x+cos(θ)cos(φ)y+sin(θ)z=0 (1)

in which θ is the angle between the plane and the z axis, and φ is the rotation determined so that the rotation is 0, when the plane intersects the xy plane along the x axis.

The sensors in the measuring arm again indicates the unambiguous place of the measuring tip 103 in the (x′, y′, z′) coordinate system. Let this information be marked with (x′ᵢ, y′ᵢ, z′ᵢ), for the time being. It can be said that the situation in FIG. 3 shows one optical positioning, from which a positioning result consisting of four values (φᵢ, x′ᵢ, y′ᵢ, z′ᵢ) will be obtained. The following examination can be done for calculating the transformation between the coordinate systems.

If the difference between the coordinate systems (x, y, z) and (x′, y′, z′) were a linear transition without rotation, the origin of the coordinate system of the measuring arm would be in the point (x₀, y₀, z₀) of the (x, y, z) coordinate system, and the place of the measuring tip given in the (x, y, z) coordinate system would be (x₀+x′ᵢ, y₀+y′ᵢ, z₀+z′ᵢ). The equation binding the position of the measuring tip to the rotation of the laser fan beam would then be

cos(θ)sin(φ)(x₀+x′ᵢ)+cos(θ)cos(φ)(y₀+y′ᵢ)+sin(θ)(z₀+z′ᵢ)=0. (2)

In this equation, unknown parameters are the values x₀, y₀ and z₀ indicating the location of the origin of the coordinate system of the measuring arm in the (x, y, z) coordinate system.

In a general case, also the rotation between the coordinate systems has to be taken into account. By means of known rotation matrices, the following expressions can be deduced for the coordinates of a rotated coordinate system (here: (x″, y″, z″) coordinate system)

$$\begin{matrix}\begin{matrix}{x}_{i}^{″} = cos ( β ) cos ( γ ) {x}_{i}^{′} + \\ ( cos ( γ ) sin ( α ) sin ( β ) - cos ( α ) sin ( γ ) ) {y}_{i}^{′} + \\ ( cos ( α ) cos ( γ ) sin ( β ) + sin ( α ) sin ( γ ) ) {z}_{i}^{′}\end{matrix} & ( 3 ) \\ \begin{matrix}{y}_{i}^{″} = cos ( β ) sin ( γ ) {x}_{i}^{′} + \\ ( cos ( α ) cos ( γ ) - sin ( α ) sin ( β ) sin ( γ ) ) {y}_{i}^{′} + \\ ( - cos ( γ ) sin ( α ) + cos ( α ) sin ( β ) sin ( γ ) ) {z}_{i}^{′}\end{matrix} & ( 4 ) \\ {z}_{i}^{″} = - sin ( β ) {x}_{i}^{′} + cos ( β ) sin ( α ) {y}_{i}^{′} + cos ( α ) cos ( β ) {z}_{i}^{′} & ( 5 )\end{matrix}$$

in which α, β, and γ) are angles of rotation around the axes of an imaginary, unrotated (x′, y′, z′) coordinate system.

When the coordinates x′ᵢ, y′ᵢ, and z′ᵢ, in the equation (2) are replaced with the new coordinates x″ᵢ, y″ᵢ, and z′ᵢ, according to the equations (3), (4) and (5), an equation valid in a general case will be obtained, which binds the location of the measuring tip to the rotation of the laser fan beam. In the equation thus obtained there are six unknown parameters: the coordinates x₀, y₀ and z₀, and the rotations α, β, and γ. The coordinate system transformation from the coordinate system of the measuring arm to the coordinate system of the optical transmitter has been determined unambiguously, when the values for the parameters x₀, y₀, z₀, α, β and γ are known. They can be determined by making six independent optical positionings in the manner shown in FIG. 3 so that the measuring tip 103 will be moved to a different point for each positioning. The result will be the mutually independent positioning results (φ₁, x″₁, Y″₁, z″₁), . . . , (φ₆, x″₆, Y″₆, z″₆). The measuring arm will stay in the same place during these positionings, i.e. the coordinate systems (x, y, z) and (x″, y″, z″) will stay the same. Each positioning will lock one degree of freedom. In other words, an equation can be written of each positioning result by requiring that the coordinates of the point in question transformed to the (x, y, z) coordinate system fulfil an equation of the plane in question in the same coordinate system. A system of equations consisting of six equations can be obtained of the positioning results (φ₁, x″₁, y″₁, z″₁), . . . , (φ₆, x″₆, y″₆, z″₆), in which there are six unknown parameters.

The equations in the system of equations are non-linear in relation to the unknown parameters, which means that it is not possible to determine the values for the parameters by means of the least squares method. However, the theory of optimisation knows several non-linear optimisation algorithms, for example, the Levenberg-Marquardt method, by which it is possible to retrieve the group of parameter values (\hat{x}₀, ŷ₀,\hat{z}₀,\hat{α}, \hat{β}, \hat{γ}), with which the system of equations is best fulfilled.

It can generally be presumed that a coordinate transformation R will transform the location of a certain point in the (x″, y″, z″ coordinate system to a location in the (x, y, z) coordinate system:

(x, y, z)=R(x″, y″, z″) (6)

Above, it has been talked about linear transition (x₀, y₀, z₀) and rotation (α, β, γ) so that the coordinate transformation R is their reverse transformation, i.e. rotation (−α, −β,−γ) and linear transition (−x₀, −y₀, −z₀). Determining the values for unknown parameters by a suitable optimisation algorithm provides the coordinate transformation R. After this as long as the measuring arm stays in the same location, any location of the measuring tip provided by its sensors can easily be transformed to the common coordinate system (of the optical locating system) by using the equation (6).

FIG. 4 illustrates a situation, which is similar to the one in FIG. 3 with the exception that the optical transmitter 201 has now been arranged to transmit two laser fan beams with different angles of deflection. The first laser fan beam hits the measuring tip 103 when the rotation of the transmitter head 213 is φ₁ (this moment is shown in FIG. 4), and the second laser fan beam would hit the measuring tip 103 when the transmitter head 213 would have some other rotation φ₂ (not shown in the Figure). Each rotation φ₁ and φ₂ determines unambiguously its own plane in the (x, y, z) coordinate system. The intersection of these planes is a straight line that goes through both the origin of the (x, y, z) coordinate system and the current location of the measuring tip 103. For one location (x″, y″, z″) of the measuring tip 103, a positioning result consisting of five values (φ₁, φ₂, x″, y″, z″) will be obtained. For establishing the coordinate transformation R, sufficiently many independent positionings will be performed, a system of equations will be written of the positioning results provided by them, and the unknowns will be solved in the same way as above.

In the cases illustrated in FIGS. 3 and 4, one optical sensor, for example APD (Avalanche PhotoDiode) will be sufficient, and it will be placed at the place of the measuring tip 103 of the measuring arm. The receiver only needs to indicate as exactly as possible the moment, when the laser fan beam hits the sensor, i.e. when the measuring tip is in the plane determined by the laser fan beam. It has been presumed in FIGS. 3 and 4 that such a simple optical receiver is so small that it cannot be separately seen in the Figures. In principle, nothing prevents the use of a receiver arrangement consisting of two or several optical sensors, in accordance with FIG. 5. Increasing the number of sensors decreases the ambiguity of a single positioning up to a certain limit, which means that fewer positionings are needed for establishing the coordinate transformation between the coordinate systems (x, y, z) and (x″, y″, z″). However, the growing complexity of the equipment will increase its manufacturing and maintenance costs, and may weaken the field competence and reliability.

The receiver arrangement with one or several sensors can be permanently integrated as part of the measuring arm, or it can be detachable so that it will be fastened to the measuring tip or at the place of the measuring tip only when needed. In the following specification it will be presumed that an optical receiver will be attached at the place of the measuring tip every time when needed for optical positioning, and replaced with a conventional measuring tip for measuring the points of an object to be measured.

FIG. 6 illustrates a system according to an advantageous embodiment of the invention and its use for measuring a large object 650. The system comprises an optical transmitter 201, an optical receiver 602, and a logic and recording unit 603. In addition, the system includes a sensor-equipped measuring arm 604. In this figure it has been presumed that the optical receiver 602 is s small receiver with one sensor, which will be attached to the measuring arm 604 so that the sensor will be at the place of the measuring tip.

In the system according to FIG. 3, the measurement of the large object 650 begins so that the measuring arm 604 will be placed to a certain position 611, from which it can measure some of the desired points of the object 650. The optical receiver 602 will be attached to the measuring arm 604, and the optical transmitter 201 and the logic and recording unit 603 will be activated. A sufficient number of positionings will be made with the optical locating system, and by means of the provided positioning results it will be possible to unambiguously calculate the coordinate transformation between the common coordinate system (bound with the optical transmitter) and the coordinate system, which the measuring arm 604 determines in its current location. The location 611 can be called a local origin. Every local origin has been marked with a small circle in FIG. 6, located in the middle of the base for the measuring arm.

When the positionings needed for the coordinate transformation have been performed with the optical locating system, the optical receiver 602 will be detached from the measuring arm 604. After this, the measuring arm 604 will be moved in a normal manner so that its measuring tip goes in turn to each point to be measured, which the measuring arm 604 can reach from its current location. The sensors in the measuring arm 604 will see to that the information concerning the movements of the measuring tip will be recorded. The location of each measured point will thus be recorded in relation to the local origin 611.

When all the points have been measured, which the measuring arm 604 can reach from its current location, the measuring arm 604 will be transferred to a new location 621. The transition can be arbitrary. For clarity let it be stated that in this specification, “moving” the measuring arm refers to a transaction, in which the base for the measuring arm is stationary in one location and the measuring tip moves, for example, to alternately contact each point to be measured. Respectively, “transferring” the measuring arm refers to a transaction, in which the measuring arm with its base will be moved to a new location; for example, from the point 611 to the point 621 in FIG. 6. In addition to or instead of transferring the measuring arm, also the object to be measured can be transferred, when seeing to the fulfilment of the conditions disclosed below.

For determining a new coordinate transformation corresponding to the new location, the optical receiver will be once more attached to the measuring arm, and the above-mentioned sufficient number of optical positionings will be performed. After having determined the new coordinate transformation by using the optical locating system, the optical receiver can again be detached and the measuring arm can be used for measuring the points in relation to the new local origin 622 that the measuring arm can reach from its new location.

In FIG. 6 it has been presumed that for measuring all desired points, the measuring arm has to be transferred still to a third place 631, in which again a new coordinate system transformation will be determined by using the optical locating system. From the third point 631 the points will be measured, which the measuring arm could not reach from the previous points 611 and 621.

Information on the optical positionings made in the different location points 611, 622 and 631 of the measuring arm and information on the location of each measured point in relation to the respective local origin will be assembled to the logic and recording unit 603. The collected information will be used for calculating the places for the measured points by transforming the places determined in relation to the local origins to places given in a certain common coordinate system. From these places given in the common coordinate system it is easy to deduce the information aimed at with the measurement, such as the distances and directions between the desired points of the object 650.

FIG. 7 illustrates the accumulation of information, when the measuring system according to the invention is used for realising the measuring method of the invention. In the simple example in the Figure it will be assumed that the final purpose of the measurement is to make sure whether the distance between certain two points in the object to be measured is correct. At 701, the optical receiver is attached to the measuring arm. In addition, the optical locating system will collect information on the timing of the moments when the lasers of the optical transmitter hit the sensors of the optical receiver, when the optical receiver is in each point to be located. At 702, the system will calculate the coordinate transformation corresponding to the first local origin between the current coordinate system of the measuring arm and the coordinate system of the optical locating system.

At 703, the measuring arm will move to the position, in which the measuring tip contacts the first point to be measured. The sensors of the measuring arm will collect the information on the movements of the measuring arm. At 704, the system will record information on the location of the first measured point in relation to the first local origin.

The points 711, 712, 713, and 714 are equal to the points 701, 702, 703, and 704 with the exception that the measuring arm is now located in a place, from which the measuring tip can reach the second point to be measured. In this case, the accumulated information and the information to be calculated naturally concern the second local origin and the second point to be measured.

At 721, the system will transform the location of the first measured point to the common coordinate system by using the first coordinate transformation. A respective transformation will be performed for the location of the second measured point at 722. Because the locations of the measured points thus obtained are in the same coordinate system, it is easy to calculate the distance between them at 731 by using Euclidian geometry.

An exemplary embodiment of the whole measuring method is shown in the form of a flow diagram in FIG. 8. The step 801 is the initialisation of the index i indicating the location of the measuring arm. In the step 802, the measuring arm is transferred to the next location, and the optical receiver is attached. In FIG. 8, the possibility has been taken in to account that it is not necessarily possible to attach the optical receiver so that the point to be located optically (an individual sensor in the embodiment in FIGS. 3 and 4) or the centre of the receiver in the embodiment in FIG. 5 would be exactly the same as the location of the measuring tip, so in the step 803, the system can be provided as a configuration parameter with the transition, which is between the point located by the optical receiver and the measuring tip. In the step 804, the optical locating system measures a sufficient number of points for determining the next coordinate transformation. In the step 805, preparations are made for the measurement by detaching the optical receiver. The loop formed by the steps 806 and 807 is repeated, until all the points have been measured, which the measuring arm can reach from its current position. If it is stated in the step 808 that the entire object has not been measured yet, the index i will be grown by one in the step 809, and returned back to the step 802. When the entire object has been measured, the information of all the points can be transformed to a common coordinate system in the step 810. In the step 811, desired information will be calculated from the measurements of the object in the common coordinate system.

It is not necessary to perform the steps of the method in this order. For example, the coordinate transformation concerning a certain local origin can be determined after having measured the points that the measuring arm can reach from the location point in question. However, performing the determination of the coordinate transformation first is a preferable solution in the sense that when measuring the points to be measured after this, all the information for transforming their locations to the common coordinate system already exists, and the transformation can be made, and when needed, it can also be shown on screen in real time.

It is also possible to determine the coordinate transformation first, then measure the points, and in between or at the end (that is, before transferring the measuring arm to a second location) make again a sufficient number of new positionings by the optical positioning system for determining the coordinate transformation. This will probably provide a slightly different result from the first measurement, because due to the non-ideality of the sensors, error has accumulated to the information representing the movements of the measuring arm. In this case it is advisable to use in the subsequent calculations the average of the locations given by the coordinate transformations determined at different times as the location of a certain point given by the coordinate transformation in the common coordinate system. A second possible variation of the order shown in FIG. 8 is that the information representing the location of each measured point will be transformed to the common coordinate system immediately after the information needed is available, i.e. when the point has been measured and the information on the coordinate trans-formation corresponding to its current location exists.

FIG. 9 is a diagrammatic view of a computer program product according to the invention, which is applicable to be executed, for example, in the logic and recording unit 603 illustrated in FIG. 6. The advance of the execution of the program is taken care of by the program execution logic 901, which contains all the actions following a conventional model, with which the execution can be made to advance from one step to another for realising the measuring method described above. The user interface 902 contains the programmatic equipment for entering the configuration information, for controlling the execution of the program, and for presenting the results to the user. The recording part 903 of the optical locating information is arranged to receive the information produced by the optical locating system, i.e. essentially the rotations of the optical measuring head that correspond to the contact of the laser fan beams with the optical sensors. The recording part 904 for the sensor information is arranged to receive the information produced by the sensors of the measuring arm, i.e. essentially the coordinates in the coordinate system of the measuring arm concerning all measured points. The part 905 for determining the coordinate transformations is arranged to determine the transformations of the coordinate systems concerning each location of the measuring arm. The part 906 for calculating the positioning information is arranged to calculate the locations of the measured points in the common coordinate system. The part 907 for calculating the measurement information is arranged to calculate the desired physical properties of the object from the position vectors of the measured points.

It is possible to make variations to the invention without deviating from the scope of protection of the patent claims. For example, even though one has above consistently talked about the use of one optical transmitter, the invention does by no means exclude the use of several optical transmitters simultaneously. One optical transmitter can be considered the minimum, with which the optical locating system can manage. The use of two optical transmitters can improve the accuracy with which the optical positioning occurs, and/or shorten the time which one optical positioning at a time requires for achieving sufficient accuracy. An even better accuracy can be achieved with three optical transmitters, and it is in this case especially possible to reduce the dependency of the accuracy of the positioning on how each location point of the measuring arm happens to be located in relation to the optical transmitters.

The above-mentioned improvement in accuracy is realised especially if the mutual locations of the optical transmitters are exactly known, i.e. the optical transmitters already have a common coordinate system. According to another embodiment of the invention measurements can be made by using two or several optical transmitters, the mutual location of which is not known at first, and which have even been positioned so that the optical receiver does not “see” all the optical transmitters. For combining the coordinate systems of two independent optical transmitters it will be enough that there is at least one location point of the measuring arm which can be observed by both optical transmitters. The optical positioning of the measuring arm will be made in the location in question in relation to each optical transmitter, and the coordinate transformations will be determined as above. Let it be assumed that the transformation from the coordinate system of the current location of the measuring arm to the coordinate system of the first optical transmitter is R₁( ), and to the coordinate system of the second optical transmitter R₂( ). The consequence of this is that the transformation from the coordinate system of the second optical transmitter to the coordinate system of the first optical transmitter is the combination R₁(R₂⁻¹( )). If the measuring arm is after this transferred to a new location, which can only be observed by the second optical transmitter, the normal optical positionings will be made in the new location in relation to the second optical transmitter, and a new coordinate transformation will be determined. The measurement results obtained from the new location can be transformed to the coordinate system of the second optical transmitter by said new coordinate transformation and further to the coordinate system of the first optical transmitter by the said combination transformation. The coordinate system of any optical-transmitter (or even the coordinate system of the measuring arm in any location point) can be selected as the common coordinate system.

The transformation of the measured points of the object to be measured to the common coordinate system does not necessarily occur in the same device as the determination of the coordinate transformation. Generally it can be thought that the system has a calculation section, which contains at least one programmable computer and which is arranged to collect the measurement information, to determine the coordinate transformation, and to use the coordinate transformation thus determined when processing the actual points to be measured. However, these calculated tasks can be distributed so that if, for example, one device collects and files the positioning results, a second device reads the filed positioning results and determines the coordinate transformation by means of them, and a third device uses the coordinate transformation obtained for processing the information representing the location of the measured points.

For determining the coordinate transformation, several optical positionings can be performed even with a multi-sensor receiver, for example, by moving the measuring arm so that the measuring tip remains in the same place, but the optical receiver attached to the measuring arm turns into different positions, or more generally, by moving the measuring arm to several different positions. In any case, it is advisable to optimise the position of the possible multi-sensor optical receiver at the phase for determining the coordinate transformations so that the difference in time when the laser beams hit them caused by the location of the sensors is as big as possible, and no ambiguity is caused to the positioning by the location of the sensors. A pin-type optical receiver with two sensors on its longitudinal axis is not the best possible one of the multi-sensor receivers, because it does not provide any information on the so-called spin position, i.e. rotation around the longitudinal axis of the optical receiver. A more unambiguous result per one location is achieved by using an optical receiver with at least three sensors, which are not all located on the same straight line. Very exact results can be obtained by the pin-type optical receiver by performing three different optical positionings for locating the local origin, the measuring arm being clearly in a different position in each location.

In principle, it is possible to make a variation of the invention, in which an optical transmitter will be attached to the measuring arm, and at least two optical receivers will be placed around the object to be measured for the duration of the measurement. The optical positionings needed for the coordinate transformations can also be made like this. However, in optical locating systems, it is most usual to place the optical transmitter in a fixed manner, and to bring the optical receiver, reflector or transponder to the point, which one wishes to locate.

Above it has also been supposed that the optical receiver will be attached to the measuring arm always only temporarily for the time for locating the local origin. It is also possible to provide the measuring arm with a fixed optical receiver, in which case less configuring will be needed during the measurement. According to still one possible variation, the measuring arm will be at the same location point during the whole measurement, but the optical transmitter will be attached to the object to be measured, and the object to be measured (and thus with it also the optical transmitter) will be transferred to different locations in relation to the measuring arm, in which locations the measuring arm can reach the different parts of the object to be measured in different ways. In this way, exactly the same result can be achieved as in the procedure specified widely above, in which the object to be measured and the optical transmitter are stationary, and the measuring arm is moved.

The determination of the plane or straight line based on a rotating laser fan beam is not the only option for realising an optical locating system. In principle, it would be possible to use as an optical transmitter a laser, which transmits a laser beam always to one direction at a time, and indicates the directional angles of this direction in the coordinate system of the optical locating system after the laser beam has been directed directly towards the optical sensor at the location of the measuring tip. The mechanical realisation and sensors of such a directional laser would, however, be more complicated than the transmitter of a rotating laser fan beam.

Further, it is not necessary for an optical transmitter to be based on laser. It is, for example, possible to provide a similar fan-shaped light pattern by a micro mirror and/or LCD technique used in data projectors.

The common coordinate system does not have to be the same as the coordinate system of the optical locating system. For example, the coordinate system of the measuring arm in its first location can be chosen as the common coordinate system. In this case, no transformations need to be made to measurements performed in the first location, but however, a transformation between the local coordinate system and the coordinate system of the optical locating system will be determined in the first location. The measurements made from other locations will be transformed in the manner described above, first to the coordinate system of the optical locating system. From there, they can further be transformed to the local coordinate system of the first location by using the above-mentioned coordinate transformations to the reverse direction.

1. A method for locating points in a common coordinate system by using a sensor-equipped measuring arm, in which method
the measuring arm will be moved so that the location of its measuring tip travels through several points, and
the information on the location of said points in the coordinate system will be collected by the sensors of the measuring arm,
characterised in that the method comprises
producing information with the optical locating system, which describe the direction, in which each said point is located seen from a fixed point in the optical locating system,
forming a system of equations, in which a set of equations binds the locations of said points in the coordinate system of the measuring arm with information describing the directions of location of said points seen from a fixed point of the optical locating system,
determining a coordinate transformation between the coordinate system of the measuring arm and the common coordinate system by determining values for the parameters in the equations of said system of equations, and
using the coordinate transformation defined in the coordinate system of the measuring arm for transforming the location of a known point to the common coordinate system.

2. A method according to claim 1, characterised in that in the method a fan-shaped light pattern is transmitted from a fixed point of the optical locating system, the fan-shaped light pattern being rotated in relation to a certain reference direction, in which case the information on the direction, in which the location point of the measuring tip is located seen from the fixed point of the optical positioning system, contains the rotation of the fan-shaped light pattern in relation to said reference direction at the moment the fan-shaped light pattern hits the location point of the measuring tip.

3. A method according to claim 2, characterised in that in the method two fan-shaped light patterns of different directions are transmitted from a fixed point of the optical locating system, the fan-shaped light patterns being rotated in relation to said reference direction, in which case the information on the direction, in which the location point of the measuring tip is located seen from the fixed point of the optical locating system, contains the rotation of both the fan-shaped light patterns in relation to said reference direction at the moment the light edge in question hits the location point of the measuring tip.

4. A method according to claim 1, characterised in that
for determining the coordinate transformation, a receiver of an optical locating system is attached to the measuring arm at the place of the measuring tip;
before or after the determination of the coordinate transformation, a measuring tip is attached to the measuring arm, and the measuring arm is moved so that the measuring arm goes to the desired points of the object to be measured, and the sensors in the measuring arm produce information on the location of such a desired point in the coordinate system of the measuring arm;
the location of the desired point is transformed to the common coordinate system by using said coordinate transformation.

5. A method according to claim 4, characterised in that for measuring such an object to be measured, all the desired points of which cannot be reached by the measuring arm from one location,
the measuring arm is transferred to at least one other location;
the coordinate transformation is determined separately in each location of the measuring arm; and
the locations of the desired points measured from each location of the measuring arm are transformed to the common coordinate system by using a coordinate transformation defined in the location in question of the measuring arm.

6. A system for locating points in a common coordinate system, the system comprising
a sensor-equipped measuring arm, comprising a measuring tip and sensors for producing information indicating the location of the measuring tip in a coordinate system of the measuring arm,
characterised in that
the system comprises an optical transmitter, which is arranged to produce information indicating the direction, in which the location point of the measuring tip is located seen from a fixed point of the optical locating system;
the system has a calculation part arranged to determine the coordinate transformation between the coordinate system of the measuring arm and a common coordinate system by forming a system of equations, in which a set of equations binds the location points of the measuring tip to the information in the coordinate system of the measuring arm, the information illustrating the directions of these location points of the measuring tip seen from a fixed point of the optical locating system, and by determining values for parameters in the equations of said system of equations, and which is further arranged to use the coordinate transformations thus determined in the coordinate system of the measuring arm for transforming the place of a known point to the common coordinate system.

7. A system according to claim 6, characterised in that said optical transmitter is arranged to transmit a fan-shaped light pattern and to rotate it in relation to a certain reference direction so that information on the direction, in which the location point of the measuring tip is located seen from a fixed point of the optical locating system, contains the rotation of the fan-shaped light pattern in relation to said reference direction at the moment the fan-shaped light pattern hits the location point of the measuring tip.

8. A system according to claim 7, characterised in that said optical transmitter is arranged to transmit two fan-shaped light patterns of different directions and to separately indicate the rotation of each fan-shaped light pattern in relation to said reference direction at the moment the fan-shaped light pattern in question hits the location point of the measuring tip.

9. A system according to claim 6, characterised in that it has one optical sensor, which is arranged to be placed to the location point of the measuring tip.

10. A system according to claim 9, characterised in that said optical sensor is located in a part, which is detachably attachable to the measuring arm at the place of the measuring tip during the optical positioning.

11. A system according to claim 9, characterised in that said optical sensor is fixedly integrated to the measuring tip.

12. A system according to claim 6, characterised in that it has an optical receiver comprising several optical sensors, the receiver being arranged to indicate the location point of the measuring tip based on the information on when light beams hit the optical sensors.

13. A system according to claim 6, characterised in that it includes a deflection sensor measuring the position of a part of the measuring arm, and that a calculation part is arranged to also use the information provided by the deflection sensor in the determination of the coordinate transformation.

14. A computer program product for measuring an object, characterised in that it comprises software means, which, executed by a computer, make the computer to perform a method comprising:
reading information provided by an optical locating system, the information indicating the directions, in which a set of different location points of the measuring tip for the sensor-equipped measuring arm is located seen from a fixed point of the optical locating system;
reading information provided by sensors of said sensor-equipped measuring arm from the location of the above-mentioned points in a coordinate system of the measuring arm;
forming a system of equations, in which a set of equations binds the locations of the above-mentioned points in the coordinate system of the measuring arm to information illustrating the directions of locations of said points seen from a fixed point of the optical locating system;
determining a coordinate transformation between the coordinate system of the measuring arm and the common coordinate system by determining values for the parameters in the equations of the above-mentioned system of equations; and
using the coordinate transformation thus determined for transforming the location of a point known in the coordinate system of the measuring arm to the common coordinate system.
